(19) United States
(12) Patent Application Publication
(10) Pub. No.: US 2003/0110477 A1
(43) Pub. Date: Jun. 12, 2003

(54) Simulation method for verifying routine execution sequence of processor

(75) Inventors: Mitsuo Wakabayashi, Kawasaki (JP); Hideki Isobe, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/284,292

(22) Filed: Oct. 31, 2002

(30) Foreign Application Priority Data
Oct. 31, 2001 (JP) 2001-335219

(51) Int. Cl. G06F 9/44

(52) U.S. Cl. 717/135

(57) ABSTRACT

A to-be-verified model 21 including a processor 23, a program RAM 24, a data RAM 25, and a peripheral I/O device 26, which are connected to each other through a bus, is described in hardware description language. A test bench 22, which requests interrupt to the processor 23 through the peripheral I/O device 26, is also described in a hardware description language. A test program 14, which includes an interrupt processing routine according to each interrupt factor and a main routine to be processed by the processor 23, is described in assembly language. A command to write the identifying code of interrupt processing routine in a trace memory region RV in the data RAM 25 is inserted in each interrupt processing routine. After simulating the to-be-verified model 21 and the test bench 22, the trace value RV is compared with an expected value EV so as to verify the interrupt routine execution sequence.

### BACKGROUND OF THE INVENTION

1. Field of the Invention

The present invention relates to a simulation method for verifying a routine execution sequence of a processor, and a debugging method, a debugger program and a recording medium thereof for verifying the routine execution sequence.

2. Description of the Related Art

When a logical design has been made for a circuit including a RAM and a MPU (Micro Processing Unit) that permits multiple interrupts, a simulation method causing an interrupt to MPU is employed for a logic verification of routine execution sequence, and a conventionally used method is that interrupt-related signal waveforms are recorded and read with a test bench and then they are compared with expected-value patterns.

However, in the conventional method, the expected-value patterns must be made out considering the interrupt-related signal waveforms in clock-cycle unit, which requires technical level of circuit-design experts. The same is also required in visual verification of the waveform without preparing the expected-value patterns. Such a problem becomes remarkable when considering there are a large combined-number of a plurality of interrupts along the time axis in result of increasing the number of verifying items. In addition, the working efficiency of verification is lowered because the expected-value patterns must be made out considering there is difference between interrupt-related signals according to different kinds of logically designed MPUs. The same problems are occurred when verifying the routine execution sequence for non-interrupt external signals.

### SUMMARY OF THE INVENTION

Therefore, it is an object of the present invention to provide a simulation method that allows easy and efficient verification of the operation of a logically designed processor with respect to external signals.

In one aspect of the present invention, there is provided with a simulation method for verifying a routine execution sequence of a processor, comprising the steps of:

(a) describing, in a hardware description language, a to-be-verified model that includes a processor and a memory unit accessed by the processor;

(b) describing, in the hardware description language, a test bench that provides an external signal to the processor;

(c) describing a test program including a plurality of routines to be processed by the processor, a routine execution sequence thereof being changed according to the external signal; and for the purpose of trace, inserting, in each routine, a command to write a routine identifying code thereof in the memory unit and to update a write address of the memory unit;

(d) simulating the to-be-verified model and the test bench; and

(e) verifying the routine execution sequence of the processor, based on a series of the routine identifying code written in the memory unit.

According to this simulation method, instead of generating the expected-value pattern of waveforms in clock-cycle unit as the conventional method, by inserting, in each routine of the test program, a command to write the routine identifying code in the memory unit and to update the write address of the memory unit, and by obtaining the expected value of routine execution sequence including a series of processing routine identifying codes in advance according to the test bench, it is possible to verify the execution sequence of the interrupt processing routine, and to easily and efficiently verify the operation of a logically designed processor with respect to the external signal, even by a person not having technical level of circuit-design experts.

In another aspect of the present invention, there is provided with a debugging method for verifying a routine execution sequence of a program including a plurality of routines, comprising the steps of:

(a) inserting, in each routine, a processing code for a processor to write a routine identifying information in a memory unit and update a write address thereof, or a processing code to write the routine identifying information in a trace file; and

(b) confirming the routine execution sequence of the program based on contents of the trace file or the memory unit, after executing the program.

According to this debugging method, inserting the processing code in each routine makes it possible to easily verify the execution sequence of the plurality of routines.

In still another aspect of the present invention, in order to easily perform the step (a) of the debugging method, there is provided with a debugger program that inserts, in a predetermined routine, in a routine including line source code of such a cursor position or in all of an interrupt processing routine, a processing code for a computer to write a routine identifying information thereof in a memory unit and update a write address thereof, or a processing code to write the routine identifying information in a trace file, in response to a predetermined manipulation of an input device.

### BRIEF DESCRIPTION OF THE DRAWINGS

FIG. 1 is a schematic functional block view of a simulation device for verifying the routine execution sequence of a processor, according to a first embodiment of the present invention.

FIG. 2 is a view showing an operation example when a to-be-verified model and a test bench are started by a simulator shown in FIG. 1.

FIG. 3 is a schematic functional block view of a simulation device for verifying the routine execution sequence of a processor, according to a second embodiment of the present invention.

FIG. 4 is a schematic functional block view of a simulation device for verifying the routine execution sequence of a processor, according to a third embodiment of the present invention.

FIG. 5 is a schematic block view of the FIFO memory shown in FIG. 4.

FIG. 6 is a schematic functional block view of a simulation device for verifying the routine execution sequence of a processor, according to a fourth embodiment of the present invention.

FIG. 7 is a schematic functional block view of a simulation device for verifying the routine execution sequence of a processor, according to a fifth embodiment of the present invention.

FIG. 8 is a view showing routine execution sequences and routine identifying codes caused by execution of routine identifying code write commands, according to a sixth embodiment of the present invention.

FIGS. 9(A) and 9(B) are views for illustrating an automatic inserting process of a routine identifying code write command, according to a seventh embodiment of the present invention.

FIG. 10 is a flow chart showing the procedure of the automatic insertion of FIG. 9.

FIG. 11 is a view for illustrating an automatic inserting process of a routine identifying code write command, according to an eighth embodiment of the present invention.

FIG. 12 is a flow chart showing the procedure of the automatic insertion of FIG. 11.

### DESCRIPTION OF THE PREFERRED EMBODIMENTS

Hereinafter, preferred embodiments of the present invention will be described in more detail referring to the drawings.

### First Embodiment

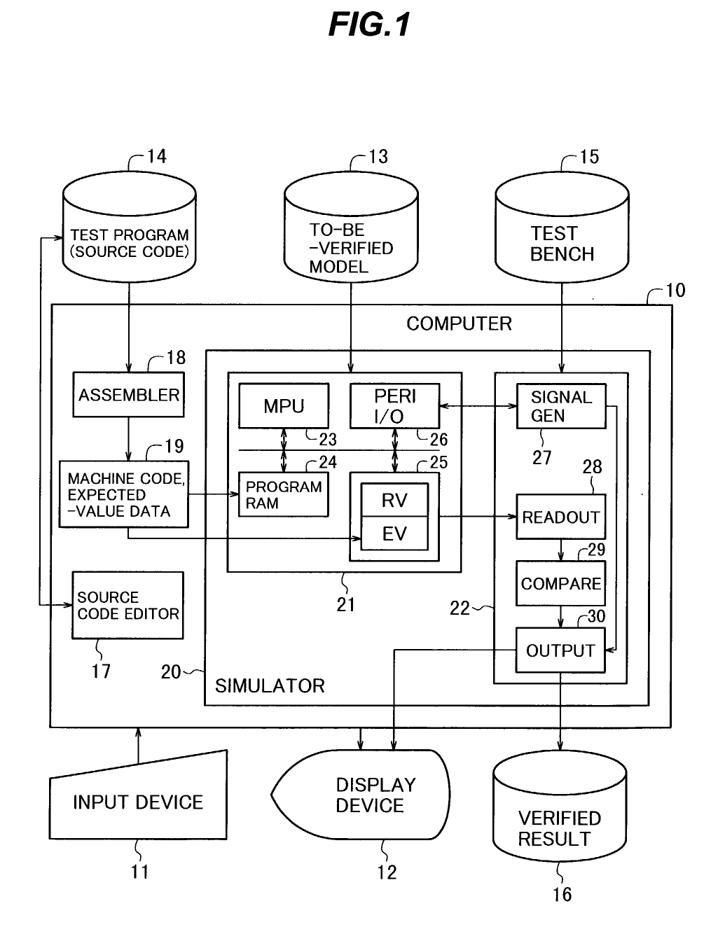

FIG. 1 is a schematic functional block view of a simulation device for verifying the routine execution sequence of a processor, according to a first embodiment of the present invention.

This device is a computer system including an input device 11, a display device 12, and an external storage device, each connected to a computer 10. The external storage device stores a logically designed model (processor) 13 to be verified, a test program 14 for operating the to-be-verified model 13, a test bench 15 that receives and transmits signals from and to the to-be-verified model 13 during the operation of the to-be-verified model 13 and verifies the routine execution sequence after the operation of the to-be-verified model 13 has been finished. The external storage device also has a region for storing the verified result 16.

Now, a description will be made of software functional blocks 17 to 30 that are executed by the computer 10.

In order to easily trace the routine execution sequence under the condition that a plurality of interrupts occur along the time axis, a source code editor 17 is started to insert write commands of respective routine identifying codes as described below in the test program 14, according to manipulation of the input device 11. The test program 14 is a source code described in assembly language, including expected-value data and a plurality of routines described with relative address, and they are converted, by an assembler 18, to an expected-value data and a machine code described with absolute address and then stored in a memory unit 19.

Both the to-be-verified model 13 and the test bench 15 have been described in hardware description language (HDL), for example Verilog™-HDL, and are converted, by a simulator 20, to each code easily executable with the computer, so as to become a to-be-verified model 21 and a test bench 22. The simulator 20 operates the to-be-verified model 21 as a simulation object and the test bench 22, in response to a start instruction generated by manipulation of the input device 11.

The to-be-verified model 21 includes a MPU 23 allowing multiple interrupts; a program RAM 24; a data RAM 25 for storing expected values EV and trace values RV of routine execution sequence corresponding to the expected values EV; and a peripheral I/O device 26, which are connected to each other through a bus. The peripheral I/O device 26 is provided with a bus master such as a DMA controller or an I/O interface having interrupt inputs. The MPU 23, the RAM 24, the RAM 25, and the peripheral I/O device 26 may be constituted as one semiconductor chip or a plurality of semiconductor chips.

In response to a load instruction generated by the manipulation of the input device 11, the simulator 20 loads the machine code and the expected-value data stored in the memory unit 19 into the program RAM 24 and the data RAM 25, respectively, of the to-be-verified model 21 through the peripheral I/O device 26, according to a program in the program RAM 24.

In the test bench 22, a signal generating unit 27 receives and transmits signals from and to the peripheral I/O device 26 during the operation of the to-be-verified model 21, according to a programmed sequence, and input and output signal waveforms of the signal generating unit 27 are supplied to an output processing unit 30.

Signals supplied from the external or execution of a memory transfer instruction using the DMA controller or the like causes the peripheral I/O device 26 to request interrupt to the MPU 23, executions of interrupt instructions, for example, INT#0 to INT#15 also generate interrupts, and also overflow of calculation result, execution of dividing calculation with a divisor “0” or the like generates an internal interrupt, thereby changing the execution routine.

After finishing the operation of the to-be-verified model 21, the readout unit 28 reads out the expected values EV and the trace values RV from the data RAM 25, and the comparing portion 29 compares the expected values EV with the respective trace values RV and supplies the comparison result to the output processing unit 30. The output processing unit 30 allows the external storage device to store the input and output waveforms and the comparison result as a verified result 16, and also allows the display device 12 to display summary of the verifying result and to display details thereof according to manipulation of the input device 11.

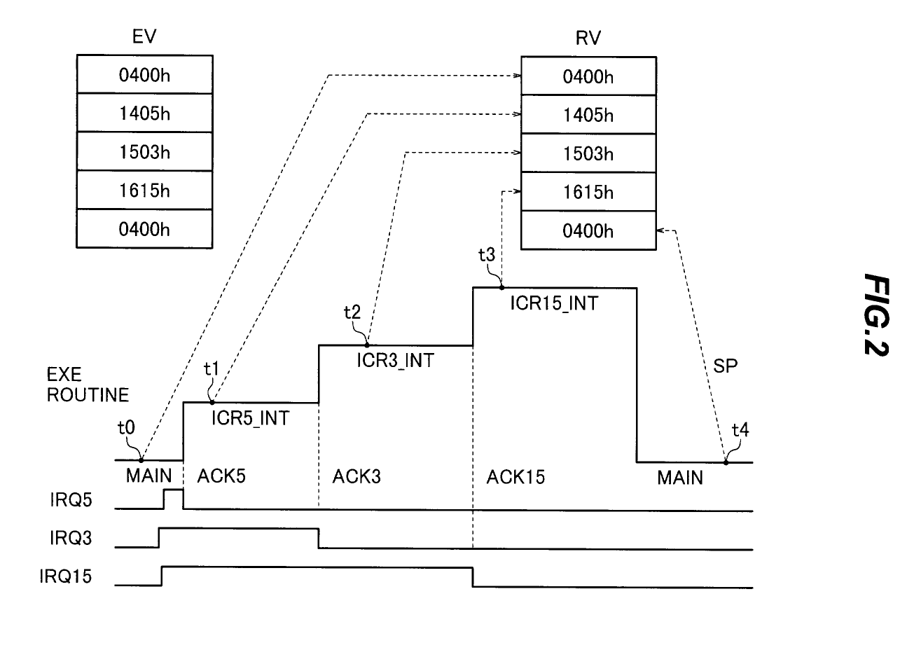

FIG. 2 is a view showing an operation example when the to-be-verified model 21 and the test bench 22 are started.

A main routine MAIN is first executed, the value of a stack pointer SP is written, as a trace value RV, into a predetermined address ADR of the data RAM 25 at a time t0, and the address ADR is incremented.

The above-mentioned write command of routine identifying code has been inserted in each interrupt processing routine. The write command is to write a code for identifying the routine under execution to a predetermined address of the data RAM 25, and also increment the predetermined address. As shown in FIG. 2, write commands are executed at times t1, t2 and t3 in interrupt processing routines ICR5_INT, ICR3_INT and ICR15_INT, respectively. There are inserted commands to write contents of a stack pointer SP as trace values RV at a time t0 before the first interrupt and at a time t4 after finishing the final interrupt process in the execution of the main routine MAIN.

For example, interrupt levels are 0 to 7, and higher priority is given to smaller value of interrupt level. One or plurality of interrupt factors correspond to each interrupt level, and an interrupt control register ICRi is provided to the MPU 23 for interrupt factor i, where “i” is one of 0 to 15, for example. The interrupt control register ICRi is to determine order of priority in same interrupt level, and to set or reset an interrupt mask. An interrupt request signal IRQi is supplied to the MPU 23 from the peripheral I/O device 26, and an acknowledge signal ACKi is supplied to the peripheral I/O device 26 from the MPU 23. The interrupt request signal IRQi corresponds to the interrupt factor i, and when the MPU 23 accepts the interrupt request signal IRQi, the acknowledge signal ACKi is activated. In response to the activation, the peripheral I/O device 26 inactivates the interrupt request signal IRQi. Upon receipt of interrupt request signal IRQi, the interrupt processing routine ICRi_INT is executed, and interrupt having smaller priority than the interrupt request signal IRQi is prohibited during the execution. Each final step of interrupt processing routines is a RETI (return from interrupt) command, and when the execution of the RETI command is completed, the interrupt prohibition is released.

As shown in FIG. 2, interrupt request signals IRQ5, IRQ3, IRQ15 rise almost at the same time, based on signals supplied to the signal generating unit 27 from the peripheral I/O device 26. When the MPU 23 is given an interrupt request during execution of a command, it accepts the interrupt request according to the priority order after finishing the execution of the command. As shown in FIG. 2, upon completion of the execution of the command, the interrupt request signals IRQ5, IRQ3, and IRQ15 are all in a high state.

The descending order of priority is IRQ5, IRQ3, and IRQ15, and the interrupt request signal IRQ5 is first accepted to activate the acknowledge signal ACK5. In response to the activation, the interrupt request signal IRQ5 falls, and in response to the falling, the acknowledge signal ACK5 is inactivated. During the execution of the interrupt processing routine ICR5_INT, a routine identifying code write command is executed at a time t1, so as to write 1405h (“h” denotes hexadecimal notation) as the routine identifying code RV and increment this write address. The most upper digit “1” of 1405h represents hardware interrupt; the next digit “4” represents interrupt level; the lower digits “05” represents that this interrupt corresponds to the interrupt control register ICR5.

Completion of the execution of RETI command in the interrupt processing routine ICR5_INT is followed by acceptance of the interrupt request signal IRQ3 of interrupt level 5, thereby executing the interrupt processing routine ICR3_INT. During the execution of the interrupt processing routine ICR3_INT, a routine identifying code write command is executed at a time t2 to write 1503h as the routine identifying code RV and its write address ADR is incremented.

Completion of the execution of RETI command in the interrupt processing routine ICR3_INT is followed by acceptance of the interrupt request signal IRQ15 of interrupt level 6, thereby executing the interrupt processing routine ICR15_INT. During the execution of the interrupt processing routine ICR15_INT, a routine identifying code write command is executed at a time t3 to write 1615h as the routine identifying code RV and its write address ADR is incremented.

Completion of the execution of RETI command in the interrupt processing routine ICR15_INT is followed by resumption of the suspended main routine MAIN, and then the value of the stack pointer SP is written as the trace value RV at a time t4.

In a case of normal operation, value of the stack pointer at the time t0 is equal to that of the stack pointer at the time t4. FIG. 2 shows the case of normal operation, that is, a case where the trace value RV of the stack pointer is equal to the corresponding expected value EV. Inserting the value of the stack pointer SP as RV also allows confirmation that the main routine is executed.

The routine identifying code write command consists of one machine code (1 command). This is because interrupt is not accepted during execution of one command, which allows writing the routine identifying code RV in the order of interrupt even when an interrupt having relatively high priority occurs during the execution of interrupt processing routine.

The following TABLE I shows a detailed example of the test program 14.

TABLE I

| PDR6 | equ 0006h |
|---|---|
| DDR6 | equ 0016h |
| EPCR | equ 00a7h ; bus control signal selection |
| ; | |
| ; CODE CSEG ABS=01h | |
| ; PROGRAM BANK=01H | |
| bank | 001h |
| org | 0f800h |
| start | |
| movw | rw1, #800h |
| mov | io EPCR, #84h |
| mov | io PDR6, #0FFH |
| mov | io DDR6, #0FFH |
| movw | a, #0400h |
| movw | sp, a |
| movw | ea @rw1+, a |
| mov | io 0a5h, #000h |
| mov | io 0a6h, #000h |
| mov | io 0a7h, #084h |
| mov | io 0b3h, #00dh ; ICR of icr3 (EI2OS) int level |
| mov | io 0b5h, #004h ; ICR of icr5 int level 4 |
| mov | io 0bfh, #006h ; ICR of delayed int level 6 |
| nop | |
| mov | ilm, #7 |
| and | ccr, #0e0h |
| or | ccr, #040h |
| movw | rw0, #0100h |
| movw | ea @rw0+, #table |
| movw | ea @rw0+, #01affh |
| movw | ea @rw0+, #00c0h |
| movw | ea @rw0, #0004h |
| nop | |
| movw | a, rw0 |
| movw | io 0f2h, a |
| movw | a, #0 |
| mov | io 94h, #3 ; enable dummy int (icr5) |
| nop | ; return from interupt |
| movw | ea @rw1+, #00001h |
| movw | a, sp |
| movw | ea @rw1+, a |
| movw | io 0e0h, a |
| movw | ea @rw1+, #0aaaah |
| nop | |
| bra | * |
| icr5_int_execute | |
| mov | io 094h, #0 ; disable dummy int |
| pushw | ps |
| popw | a |
| movw | io 0e0h, a |
| movw | a, #01405h |
| movw | io 0e0h, a |
| mov | io 0b5h, #7 ; disable icr5 |
| movw | a, sp |
| movw | ea @rw1+, #01405h |
| movw | io 0e0h, a |
| nop | |
| mov | io 094h, #3 ; enable dummy int (icr3) |
| mov | io 09fh, #1 ; enable delayed int |
| reti | |
| nop | |
| nop | |
| icr3_int_execute | |
| pushw | ps |
| popw | a |
| movw | io 0e0h, a |
| movw | a, #01503h |
| movw | io 0e0h, a |
| mov | io 0b3h, #7 ; disable icr3 |
| movw | a, sp |
| movw | ea @rw1+, #01503h |
| movw | io 0e0h, a |
| nop | |
| reti | |
| nop | |
| nop | |
| icr15_int_execute | |
| pushw | ps |
| popw | a |
| mov | io 09fh, #0 ; disable delayed int |
| movw | io 0e0h, a |
| movw | a, #01615h |
| movw | io 0e0h, a |
| mov | io 094h, #0 |
| movw | a, sp |
| movw | ea @rw1+, #01615h |
| movw | io 0e0h, a |
| nop | |
| reti | |
| nop | |
| nop | |
| ; end of check program | |
| bra | * |
| bank | 0ffh |
| org | 0ff00h |
| table | |
| db | 000h |
| db | 001h |
| db | 002h |
| db | 003h |
| db | 004h |
| db | 005h |
| db | 006h |
| db | 007h |
| db | 008h |
| db | 009h |
| db | 010h |
| bank | 0ffh |
| org | 0ffa4h ; icr5 |
| dw | icr5_int_execute |
| db | 001h |
| db | 068h |
| org | 0ffb4h ; icr3 |
| dw | icr3_int_execute |
| db | 001h |
| db | 068h |
| org | 0ff54h ; icr15 |
| dw | icr15_int_execute |
| db | 001h |
| db | 068h |
| org | 0ffdch |
| dw | start |
| db | 001h |
| db | 0a9h |
| end | |

For example, in the above-described program, a label “icr5_int_execute” is the name of the interrupt processing routine that corresponds to icr5, and this routine consists of from the step next to the label to “reti”. Referring to routine code write command “movw ea @rw1 +, #01405h” in this routine, “movw”, “ea”, and “@rw1” denote one word transfer command, execution address, and indirect address rw1, respectively,; “+” denotes that upon completion of one word transfer, contents of the indirect address rw1 is incremented; and “#01405h” denotes that the immediate value is 01405h. That is, this command is to store the immediate value 01405h as the routine identifying code in the address @rw1 and then increment the address @rw1.

Next, the following TABLE II shows a detailed example of the test bench 15 in a case of adopting Verilog™-HDL as HDL.

TABLE II

| \grave{ }timescale 10ps/10ps | |
|---|---|
| module test; | |
| integer i, da; | |
| reg [15:0] result [0:1023]; | |
| initial da=$fopen(“i2os.data”); | |
| \grave{ }include “simHeader.inc” | |
| initial | |
| begin | |
| $display (“Verilog start [sim]”); | |
| UseEXTROM = 1; | |
| CLKE=1; | |
| StartDump; | |
| #(10000*600) | MD2 = 1; |
| #(10000 ) | RSTX = 0; HSTX = 0; |
| #(10000*256) | HSTX = 1; |
| #(10000*4 ) | MD1 = 1; |
| #(10000*4 ) | MD0 = 1′b0; // VDA9 sync |
| #(10000*10 ) | RSTX = 1′b1; // power on reset |
| #(10000*4 ) | RSTX = 1′b0; // clock sync |
| #(10000*20 ) | MD0 = 1′b1; // VDA9 sync |
| #(10000*10 ) | RSTX = 1′b1; // power on reset |
| #(10000*4 ) | RSTX = 1′b0; // clock sync |
| MD2 = 1; MD1 = 0; MD0 = 1; | |
| #(10000*4 ) | RSTX = 1′b1; // release reset |
| #(10000*128) ; | |
| for (i = 0; i < 6; i = i + 1) begin | |
| #(10000*128) ; | |
| #(10000*4 ) | Irq = 8′hfe; // IRQ0 active |
| #(10000*16 ) | Irq = 8′hff; |
| #(10000*32 ) ; | |
| end | |

#(10000*320 ) ;
for (i = 0; i < 32; i = i + 1) begin
result[i] = {test.A0.DA.A401.RAM2KP[1024+i],

test.A0.DA.A416.RAM2KP[1024+i]};

$display(“result(%d) = %x ”, i, result[i]);
$fdisplay(da, “%x”, result[i]);
end
$fclose(da);$finish; // for bus function check
end
endmodule

Next, the following TABLE III shows a detailed example of comparison result between the routine identifying code RV and the expected value EV, among the comparison result 16.

TABLE III

Verilog start [sim (V01L01)]
*** DATA GOOD (0) result=0400 expect=0400 ***
*** DATA GOOD (1) result=1405 expect=1405 ***
*** DATA GOOD (2) result=1503 expect=1503 ***
*** DATA GOOD (3) result=1615 expect=1615 ***
*** DATA GOOD (4) result=0001 expect=0001 ***
*** DATA GOOD (5) result=0400 expect=0400 ***
*** DATA GOOD (6) result=aaaa expect=aaaa ***

According to the first embodiment, instead of generating the expected-value pattern of waveforms in clock-cycle unit as the conventional method, by inserting the routine identifying code write command in each interrupt processing routine of the test program 14, and by obtaining in advance the expected value of routine execution sequence including a series of routine code depending on the test bench 15, it is possible to verify the execution sequence of the interrupt processing routine, and to easily and efficiently perform this verification even by a person not having technical level of circuit-design experts.

### Second Embodiment

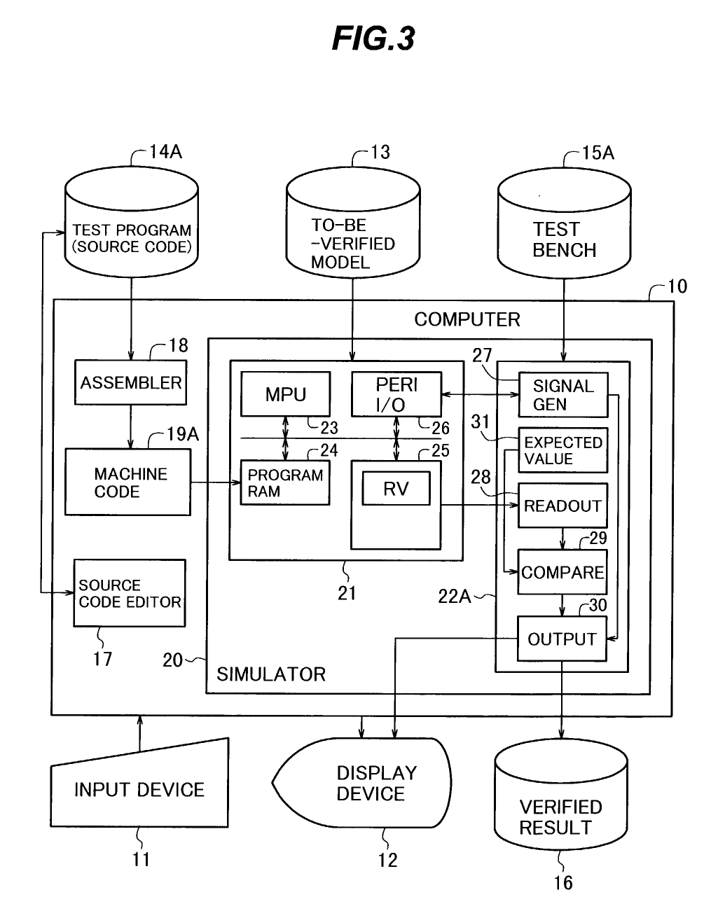

FIG. 3 is a schematic functional block view of a simulation device for verifying the routine execution sequence of a processor, according to a second embodiment of the present invention.

In this embodiment, the expected-value data is not included in a test program 14A, but in a test bench 15A. Correspondingly, the expected-value data has not been stored in a memory unit 19A, but in the memory unit 31 of a test bench 22A. Therefore, the readout unit 28 reads out only a routine identifying code RV from the data RAM 25, and the comparing portion 29 compares the readout routine identifying code RV with the expected value of an expected value memory unit 31.

The others are the same as the first embodiment.

The second embodiment makes it possible that one test program 14A copes with a plurality of test benches 15A. In addition, the second embodiment has more definite correlation between the signal generating unit 27 and the expected-value data, because the expected-value data stored in the memory 31 is made out according to sequence of the signal exchange of the signal generating unit 27.

### Third Embodiment

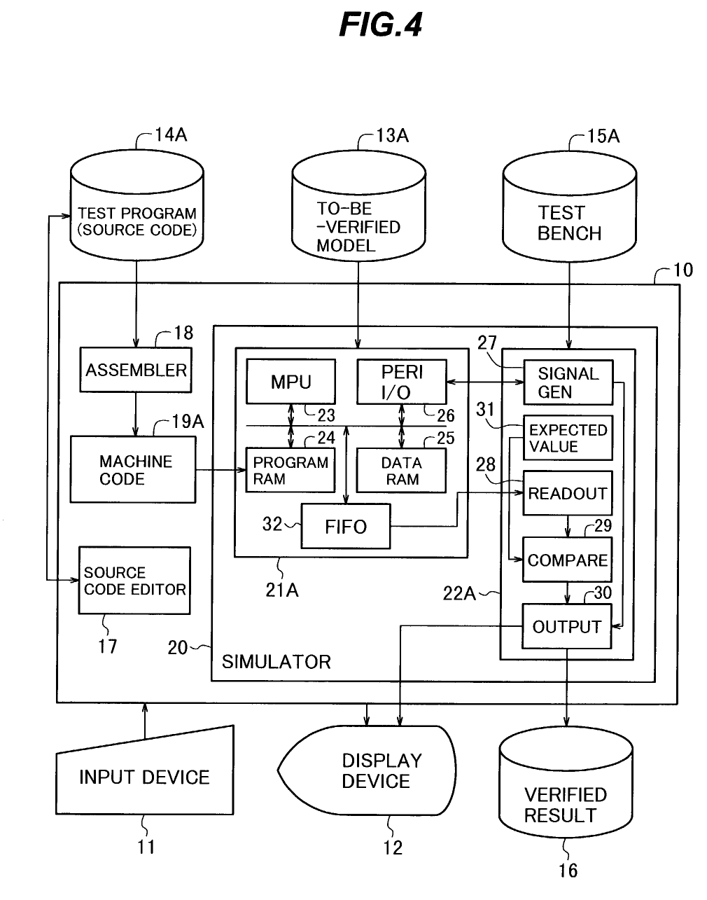

FIG. 4 is a schematic functional block view of a simulation device for verifying the routine execution sequence of a processor, according to a third embodiment of the present invention.

This embodiment is provided with a to-be-verified model 13A different from the to-be-verified model 13 shown in FIG. 3. In more detail, the to-be-verified model 21A is provided with a FIFO (First In First Out) memory 32 for storing a trace value RV, in addition to the to-be-verified model 21 shown in FIG. 3, and the trace value RV is not stored in the data RAM 25.

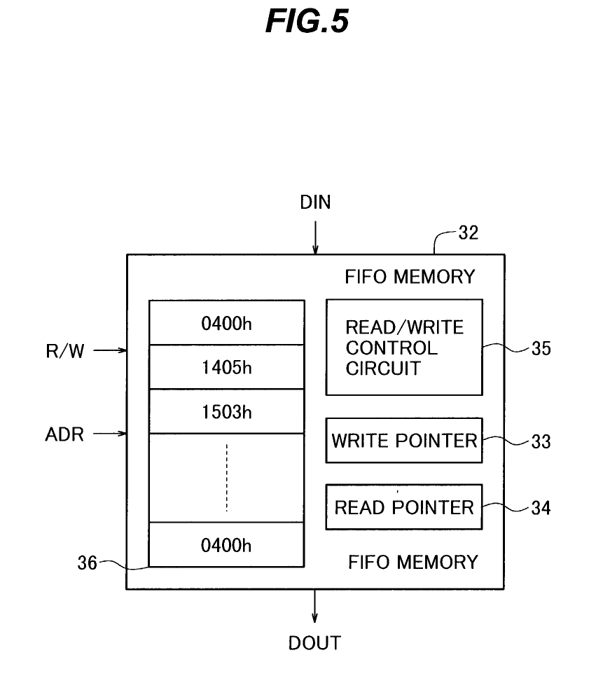

FIG. 5 is a schematic block view of the FIFO memory 32.

In the initial state, a write pointer 33 and a read pointer are cleared to zero. When the address ADR points to the FIFO memory 32, if a read/write signal R/W is low, a read/write control circuit 35 writes a data DIN into the address in a memory 36 pointed by the write pointer 33, and increments the write pointer 33, while if the signal R/W is high, it reads out data from the address in the memory 36 pointed by the read pointer 34, outputs the read data as DOUT, and increments the read pointer 34. FIG. 5 shows a case where the same trace value RV of routine identifying code as that of FIG. 2 is stored in the memory 36.

By using such a FIFO memory 32, the write pointer 33 in the FIFO memory 32 is automatically incremented, and the FIFO memory 32 may be pointed with one address value. Therefore, even when the command set of the MPU 23 has no auto-incrementable command “movw” used in the first embodiment, a routine identifying code write command consisting of one command can be inserted in each interrupt processing routine.

In addition, the FIFO memory 32 can be used only for the verification, without being actually used. Furthermore, a LIFO (Last In First Out) memory may be used, instead of the FIFO memory 32.

### Fourth Embodiment

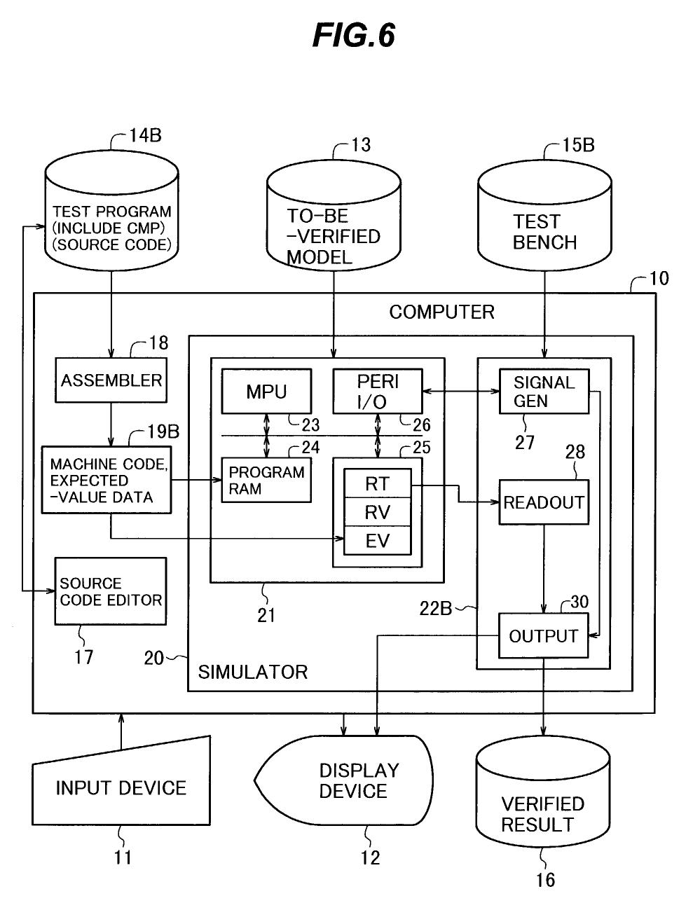

FIG. 6 is a schematic functional block view of a simulation device for verifying the routine execution sequence of a processor, according to a fourth embodiment of the present invention.

In this embodiment, the comparing program CMP is not included in a test bench 15B, but in a test program 14B. That is, the comparing portion 29 shown in FIG. 1 is not included in a test bench 22B, and the comparing program is included in a machine code of a memory unit 19B. The comparing program is, for example, a subroutine called from the final step of the main routine MAIN which compares the trace value RV with the expected value EV stored in the data RAM 25, and then stores the comparison result RT in the data RAM 25. The comparing program can be commonly used in any kind of MPU 23. The readout unit 28 of the test bench 22B supplies the comparison result RT to the output processing unit 30.

According to the fourth embodiment, the test bench 22 B has a simple configuration.

### Fifth Embodiment

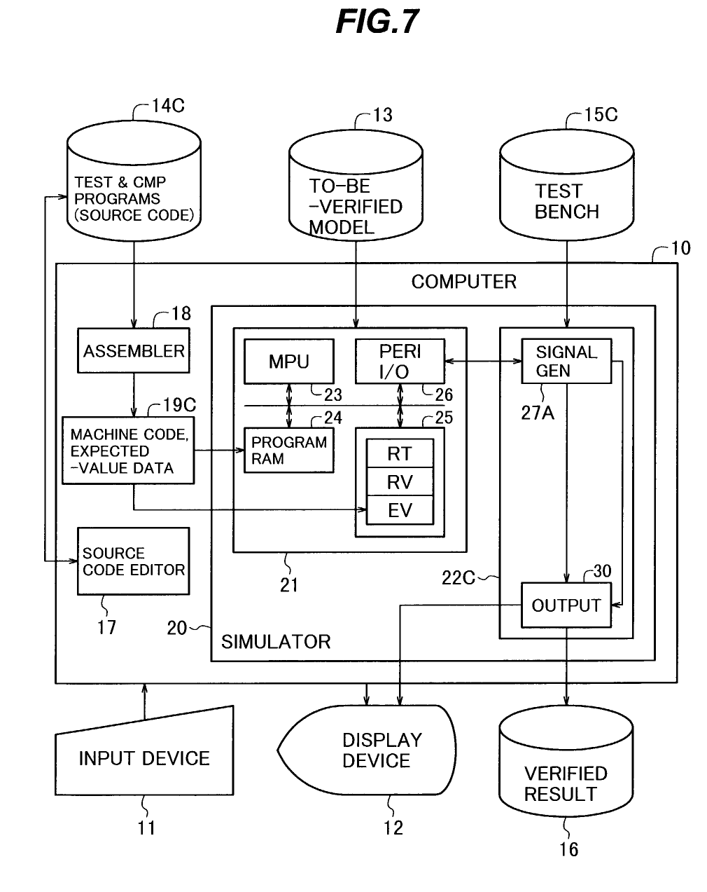

FIG. 7 is a schematic functional block view of a simulation device for verifying the routine execution sequence of a processor, according to a fifth embodiment of the present invention.

In this embodiment, a test program 14C is prepared so that the comparison result RT stored in the data RAM 25 is read out to a signal generating unit 27A of a test bench 22C through the peripheral I/O device 26 and then is supplied to the output processing unit 30.

The others are the same as the fourth embodiment.

### Sixth Embodiment

In a sixth embodiment, in FIG. 1 for example, the routine identifying write command is inserted right before the RETI command and right before the beginning command of each interrupt processing routine through the source code editor 17, based on the manipulation of the input device 11.

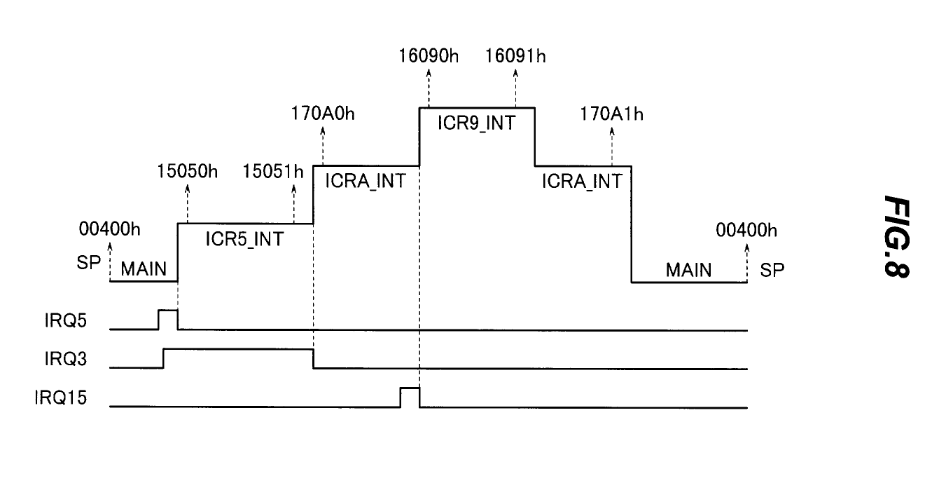

FIG. 8 shows the routine execution sequence and the routine identifying code caused by execution of the routine identifying code write command in such a case.

In the first step of the interrupt processing routine ICRA_INT, a routine identifying code write command is executed, thereby storing “170A0h” as the routine identifying code RV. During the execution of this routine, an interrupt request signal IRQ9 having higher priority than an interrupt request signal IRQA is accepted, thereby executing an interrupt processing routine ICR9_INT. After finishing the execution of this routine, the remaining process of the interrupt processing routine IRA_INT is executed, where a routine identifying code write command is executed, thereby storing “170A1h” as the routine identifying code RV.

This makes it possible to discriminate, using the trace value RV, whether it is after finishing or by interrupting the execution of the interrupt processing routine ICRA_INT that the interrupt processing routine ICR9_INT is carried out.

In addition, as shown in FIG. 8, a command to write contents of a stack pointer SP as the routine identifying code RV is inserted at the beginning and at the end of the main routine MAIN.

### Seventh Embodiment

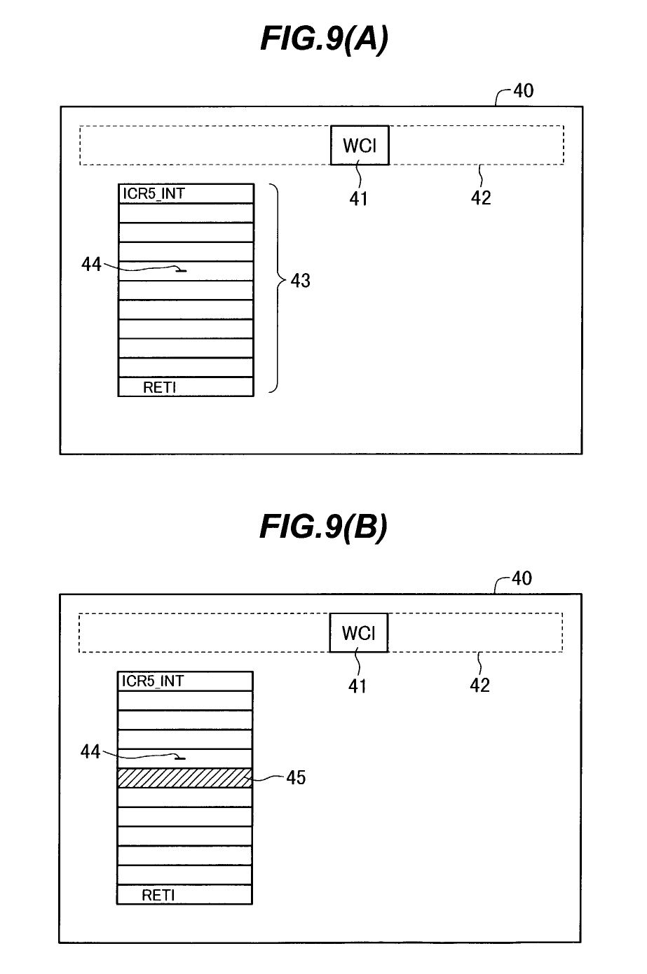

FIG. 9(A) is a view showing a schematic screen of the display device 12, for example, during operation of the source code editor 17 shown in FIG. 1.

A tool bar 42 including a button 41 for inserting a routine identifying code write command is displayed on the upper portion of the screen 40. A source code of some interrupt processing routine 43 is displayed under the tool bar 42. A cursor 44 is positioned within the interrupt processing routine 43. In this state, pointing and clicking the button 41 for inserting a routine identifying code write command with a pointing device causes the routine identifying code write command 45 to be automatically inserted in a row next to the cursor 44 as shown in FIG. 9(B).

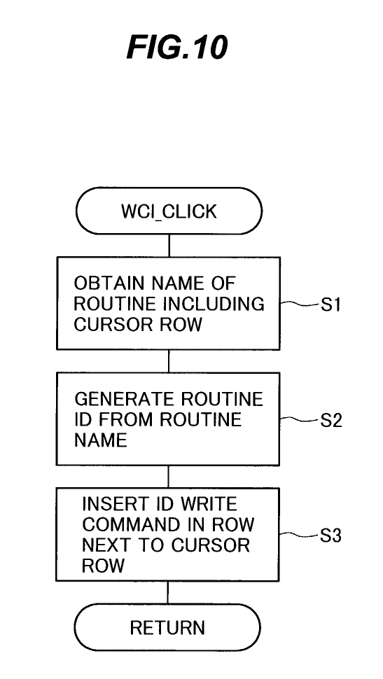

FIG. 10 shows a flow chart of the procedure of such an automatic insertion.

(S1) Obtained is the name of a routine that includes the source code of the row where the cursor 44 is positioned. In the case of FIG. 9(A), obtained is the beginning label “ICR5_INT” of the interrupt processing routine 43.

(S2) A routine identifying code is generated from the routine name according to a predetermined rule. For example, the fourth character “5” from the beginning of this label is determined as the routine identifying code.

(S3) The routine identifying code write command 45 is inserted in the row next to the cursor row.

The seventh embodiment makes it possible to easily perform the process for inserting the routine identifying code write command.

### Eighth Embodiment

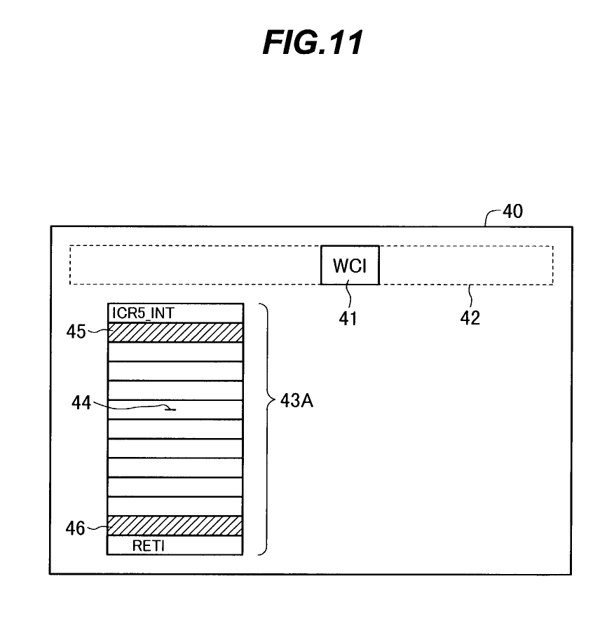

In an eighth embodiment, in the state of FIG. 9(A), pointing and clicking the button 41 for inserting a routine identifying code write command with a pointing device causes routine identifying code write commands 45 and 46 to be automatically inserted before the RETI command and before the beginning command of the interrupt processing routine 43, respectively, as shown in FIG. 11.

This makes it possible to easily perform the process in the sixth embodiment for inserting the routine identifying code.

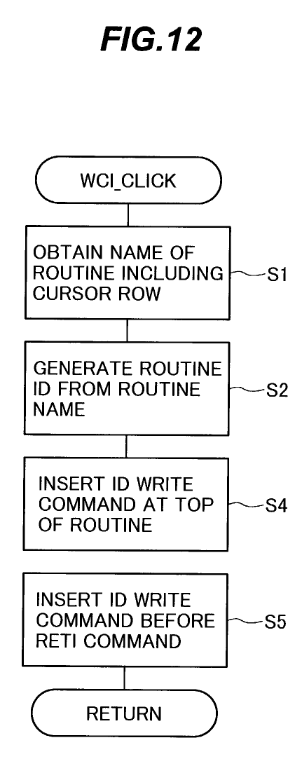

FIG. 12 shows a flow chart of the procedure of this automatic insertion.

Steps (S1) and (S2) are the same as those of FIG. 10.

(S4) A routine identifying code write command, for example “movw ea @rw1+, #50h”, which includes, as an immediate value (routine identifying code), both the routine identifying code generated in step S2 and “0” representing the beginning, is inserted next to the identifying label of the routine that includes the source code of the row where the cursor 44 is positioned.

(S5) A routine identifying code write command, for example “movw ea @rw1+, #51h”, which includes, as an immediate value (routine identifying code), both the routine identifying code generated in step S2 and “1” representing it is before RETI command of this routine, is inserted before the RETI command.

Although preferred embodiments of the present invention has been described, it is to be understood that the invention is not limited thereto and that various changes and modifications may be made without departing from the spirit and scope of the invention.

For example, the routine identifying code write command may comprise a plurality of steps. In this case, the interrupt mask is set at the beginning, and reset at the end. Further, a command to write, as a trace value RV, contents of a status register for indicating the state of hardware (to-be-verified model), such as transmitting and receiving error, and to change the write address for the next write, together with the routine identifying write command, may be inserted in the test program 14. This status register is included in the MPU 23 or the peripheral I/O device 26 or the like.

The present invention may be applied to a case of verifying the execution of a command or a routine that is changed by an external signal other than interrupt signal.

Furthermore, the seventh and eighth embodiments may be used for debugging various programs, as well as for the simulation method for verifying the routine execution sequence of a processor. In this case, the trace value RV of the routine identifying code may be stored in a trace result file, and the expected value EV does not have to be prepared in advance.

In addition, the present invention may have such a configuration that in response to instruction such as clicking the button 41 for inserting a routine identifying code write command, the routine identifying code write command is automatically inserted in all interrupt processing routines or all routines.

What is claimed is:

1. A simulation method for verifying a routine execution sequence of a processor, comprising the steps of:
(a) describing, in a hardware description language, a to-be-verified model that includes a processor and a memory unit accessed by the processor;
(b) describing, in the hardware description language, a test bench that provides an external signal to the processor;
(c) describing a test program including a plurality of routines to be processed by the processor, a routine execution sequence thereof being changed according to the external signal; and for the purpose of trace, inserting, in each routine, a command to write a routine identifying code thereof in the memory unit and to update a write address of the memory unit;
(d) simulating the to-be-verified model and the test bench; and
(e) verifying the routine execution sequence of the processor, based on a series of the routine identifying code written in the memory unit.

2. The simulation method according to claim 1, wherein the processor allows interrupt; the external signal includes an interrupt signal; and the test program includes an interrupt processing routine according to an interrupt factor.

3. The simulation method according to claim 2, wherein in the step (c), the command is inserted both at a beginning of the interrupt processing routine and right before a return-from-interrupt command.

4. The simulation method according to claim 2, which further comprises the step of:
(f) storing, in the memory unit or other memory unit, an expected value of a series of the identifying code of the interrupt processing routine before the simulation,
wherein in the step (e), the series of the identifying code of the interrupt processing routine is compared with the expected value after the simulation.

5. The simulation method according to claim 3, wherein the test bench of the step (b) includes a program for performing the comparison.

6. The simulation method according to claim 3, wherein the test program of the step (c) includes a program for performing the comparison, and the comparison of the step (e) is performed by the processor according to the program for performing the comparison.

7. The simulation method according to claim 3, wherein the expected value of the step (f) is stored in said other memory unit, and said other memory unit is included in the test bench.

8. The simulation method according to claim 1, wherein the memory unit of the step (a) has a FIFO memory or a LIFO memory unit, and the predetermined address of the step (c) is to select the FIFO memory or the LIFO memory unit.

9. The simulation method according to claim 2, wherein the identifying code of the interrupt processing routine of the step (c) includes a portion indicating whether it is a hardware interrupt or a software interrupt, its corresponding interrupt control register number in case where it is the hardware interrupt, and an interrupt command number in case where it is the software interrupt.

10. The simulation method according to claim 1, wherein in the step (c), a command to write a value of a stack pointer in a predetermined address of the memory unit is also included in a main routine among the plurality of routines.

11. A debugging method for verifying a routine execution sequence of a program including a plurality of routines, comprising the steps of:
(a) inserting, in each routine, a processing code for a processor to write a routine identifying information in a memory unit and to change a write address thereof, or a processing code to write the routine identifying information in a trace file; and
(b) confirming the routine execution sequence of the program based on contents of the trace file or the memory unit, after executing the program.

12. The debugging method according to claim 11, wherein in the step (a), provided that the routine is an interrupt processing routine, the processing code is inserted both at a beginning of the interrupt processing routine and right before a return-from-interrupt command.

13. A debugger program that inserts, in a predetermined routine, a processing code for a computer to write a routine identifying information thereof in a memory unit and update a write address thereof, or a processing code to write the routine identifying information in a trace file, in response to a predetermined manipulation of an input device.

14. The debugger program according to claim 13, wherein the predetermined routine is a routine including a source code of a row where a cursor is positioned.

15. The debugger program according to claim 13, wherein the predetermined routine is each of all interrupt processing routines.

16. The debugger program according to claim 13, wherein a position where the processing code is inserted is one row before or after a row where a cursor is positioned.

17. The debugger program according to claim 13, wherein a position where the processing code is inserted is a beginning processing step and an end processing step of the routine.

18. A computer-readable recording medium in which the debugger program defined in claim 13 has been recorded.
